(19) United States
(12) Patent Application Publication
(10) Pub. No.: US 2025/0163656 A1
(43) Pub. Date: May 22, 2025

(54) PLATE COMPACTOR

(71) Applicant: MILWAUKEE ELECTRIC TOOL CORPORATION, Brookfield, WI (US)

(72) Inventors: Evan M. Glanzer, Milwaukee, WI (US); John E. Koller, Waukesha, WI (US)

(21) Appl. No.: 19/032,751

(22) Filed: Jan. 21, 2025

Related U.S. Application Data
(63) Continuation of application No. 18/365,333, filed on Aug. 4, 2023, now Pat. No. 12,234,613.
Application No. 18/365,333 is a continuation of application No. 17/369,489, filed on Jul. 7, 2021, now Pat. No. 12,065,790.
(60) Provisional application No. 63/059,250, filed on Jul. 31, 2020.
(60) Provisional application No. 63/048,722, filed on Jul. 7, 2020.

(51) Int. Cl. E01C 19/38; E01C 19/28; E02D 3/074; H02K 7/06

(52) U.S. Cl. CPC E01C 19/38; E01C 19/285; E02D 3/074; H02K 7/061

(57) ABSTRACT

A compactor includes a plate and an electric motor coupled to the plate. The electric motor includes a first shaft configured to rotate about a first rotational axis. The compactor further includes an eccentric mass coupled to a second shaft and configured to rotate about a second rotational axis in response to receiving torque from the electric motor. The first rotational axis is parallel to the second rotational axis. The compactor further includes a battery configured to provide power to the electric motor. The compactor further includes a gear configured to receive torque from the electric motor. The gear transmits the torque to the second shaft to rotate the eccentric mass.

### CROSS-REFERENCE TO RELATED APPLICATIONS

This application is a continuation of co-pending U.S. patent application Ser. No. 18/365,333 filed on Aug. 4, 2023, which is a continuation of U.S. patent application Ser. No. 17/369,489 filed on Jul. 7, 2021, now U.S. Pat. No. 12,065,790, which claims priority to U.S. Provisional Patent Application No. 63/059,250 filed on Jul. 31, 2020 and U.S. Provisional Patent Application No. 63/048,722 filed on Jul. 7, 2020, the entire contents of all of which are incorporated herein by reference.

### FIELD OF THE INVENTION

The present invention relates to plate compactors.

### BACKGROUND OF THE INVENTION

Plate compactors include a plate that is caused to vibrate in order to compact soil or other loose material.

### SUMMARY OF THE INVENTION

The present invention provides, in one aspect, a compactor including a plate and an electric motor coupled to the plate. The electric motor includes a first shaft configured to rotate about a first rotational axis. The compactor further includes an eccentric mass coupled to a second shaft and configured to rotate about a second rotational axis in response to receiving torque from the electric motor. The first rotational axis is parallel to the second rotational axis. The compactor further includes a battery configured to provide power to the electric motor. The compactor further includes a gear configured to receive torque from the electric motor. The gear transmits the torque to the second shaft to rotate the eccentric mass.

The present invention provides, in another aspect, a compactor including a plate, a handle, a vibration isolator coupling the handle to the plate, and an electric motor coupled to the plate and including a first shaft configured to rotate about a motor axis. The compactor further includes an exciter coupled to the plate and configured to vibrate the plate in response to receiving torque from the electric motor. The exciter includes a second shaft parallel with the motor axis and an eccentric mass attached thereto. The compactor further includes a battery configured to provide power to the electric motor. The compactor further includes a gear train rotationally coupling the first shaft and the second shaft. The gear train transfers torque from the electric motor to the exciter, causing the eccentric mass to rotate.

The present invention provides, in yet another aspect, a compactor including a plate, an electric motor coupled to the plate and including a first shaft configured to rotate about a motor axis, control electronics configured to control operation of the electric motor, a vibration isolator coupling the control electronics to the plate, and an exciter coupled to the plate and configured to vibrate the plate in response to receiving torque from the electric motor. The exciter includes a second shaft parallel with the motor axis and an eccentric mass attached thereto. The compactor further includes a battery configured to provide power to the electric motor. The compactor further includes a gear train rotationally coupling the first shaft and the second shaft. The gear train transfers torque from the electric motor to the exciter, causing the eccentric mass to rotate.

### BRIEF DESCRIPTION OF THE DRAWINGS

FIG. 1 is a schematic plan side view of a plate compactor.

FIG. 2 is a schematic plan side view of a plate compactor according to an embodiment of the invention.

FIG. 2A is a perspective view of a plate compactor according to another embodiment of the invention.

FIG. 3 is a schematic top plan view of the plate compactor of FIG. 2.

FIG. 4 is a schematic top plan view of a plate compactor according to another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

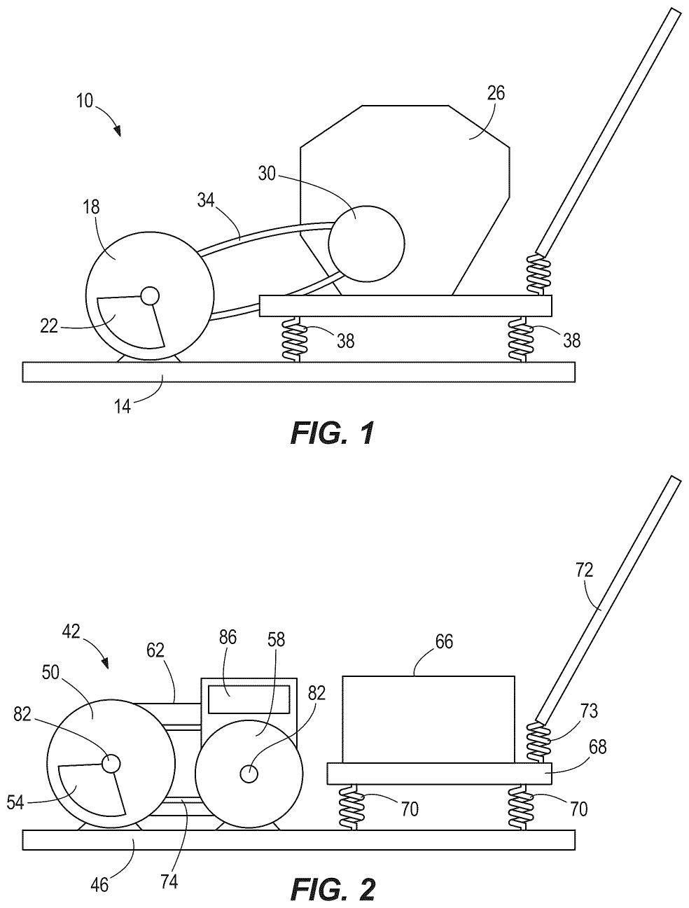

As shown in FIG. 1, a typical gas-powered plate compactor 10 includes a plate 14, an exciter 18 with an eccentric mass 22 to vibrate the plate 14, and a gas engine 26 to drive the exciter 18 via an output pulley 30 and a belt 34. The gas engine 26 is vibrationally isolated from the exciter 18, via vibration isolators 38 or dampers, to protect the gas engine 26 from excessive vibration. While minimizing vibration is good, this arrangement is not efficient. To maximize runtime in battery powered systems, efficiency is critical because battery energy density is currently significantly lower than gasoline.

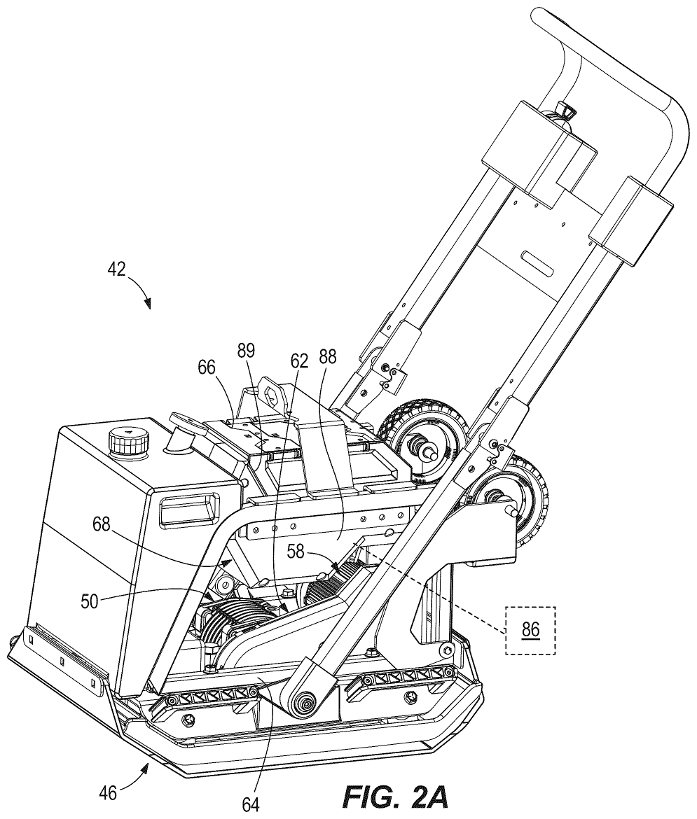

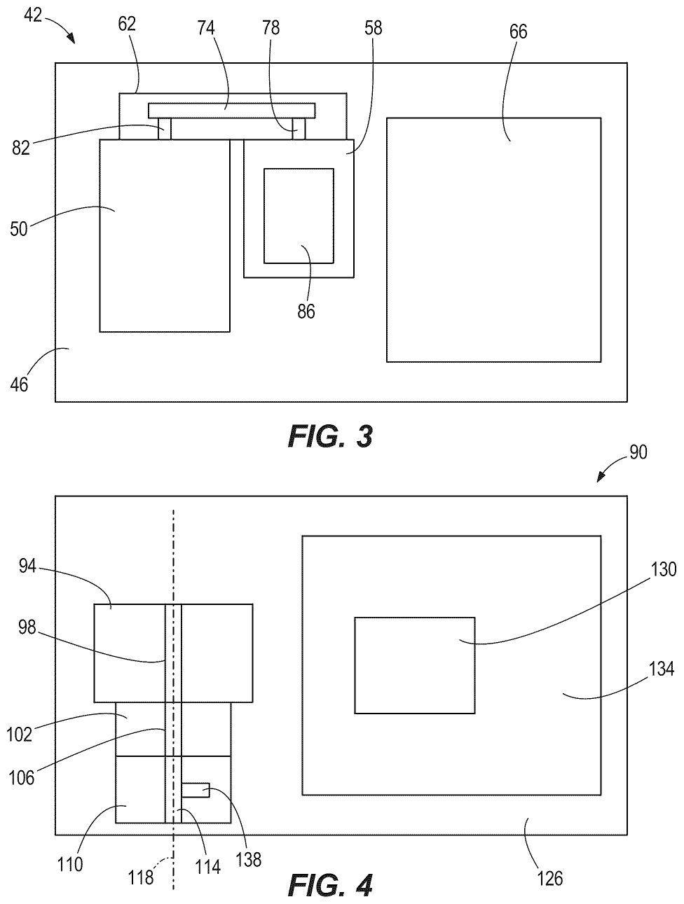

FIGS. 2 and 3 illustrate an embodiment of a plate compactor 42 including a plate 46, an exciter 50 with an eccentric mass 54 to vibrate the plate 46, and an electric motor 58 to drive the exciter 50 via a torque transfer device 62 (e.g., a transmission, an endless drive member such as a roller chain or a belt, and/or a gear train). Although the plate 46 is schematically illustrated as a single body, the plate 46 may comprise a combination of rigidly connected components that facilitate sliding the compactor 42 across a work surface to be compacted. A battery 66 (e.g., a battery pack) powers the electric motor 58. The battery 66 is mounted on a platform 68 that is vibrationally isolated from the electric motor 58 by vibration isolators 70 or dampers between the platform 68 and the plate 46. Thus, the battery 66 is vibrationally isolated from the electric motor 58. Likewise, a handle 72 is coupled to and vibrationally isolated from the platform 68 via another vibration isolator 73. Alternatively, the handle 72 may instead be coupled to the plate 46.

The electric motor 58 and the exciter 50 are directly coupled to the plate 46 so that there is no relative motion (i.e., axial displacement) between them. The torque transfer device 62 includes a gear train 74, for example, that transfers torque from a motor shaft 78 to an exciter shaft 82. Thus, the gear train 74 permits the exciter 50 to be driven faster or slower than the electric motor 58. In the embodiment of FIGS. 2 and 3, control electronics 86 for controlling operation of the electric motor 58 are coupled to the electric motor 58 for cooling purposes, but in other embodiments, the control electronics 86 can be mounted on a portion of the plate compactor 42 that is vibrationally isolated from the exciter 50, such as the platform 68 along with the battery 66. In an embodiment of the compactor 26 in which the platform 68 is configured as a housing 88 defining thereon a battery receptacle 89 to which the battery 66 is connectable (FIG. 2A), the control electronics 86 may be located within the housing 88. In some embodiments, the compactor 26 may include an intermediate frame 64 interconnecting the housing 88 and the plate 46 (e.g., via additional vibrational isolators 73). In operation of the plate compactor 42, the control electronics 86 control operation of the electric motor 58, which drives the exciter 50 via the gear train 74, thus rotating the eccentric mass 54 about the exciter shaft 82, imparting vibration to the plate 46.

FIG. 4 illustrates another embodiment of a plate compactor 90 that is similar to the embodiment of FIGS. 2 and 3, except that an electric motor 94, motor shaft 98, gearbox 102, exciter 110, and exciter shaft 114 are arranged on a rotational axis 118. The gearbox 102, gear train 106, exciter 110, exciter shaft 114, and an eccentric mass 138 are all on one side of the electric motor 94. As in the embodiment of FIGS. 2 and 3, the electric motor 94 and the exciter 110 are directly coupled to a plate 126 so that there is no relative motion (i.e., axial displacement) between them. In the embodiment of FIG. 4, control electronics 130 could be mounted with the electric motor 94 or could be mounted with a battery 134, as shown in FIG. 4. In operation of the plate compactor 90, the control electronics 130 control operation of the electric motor 94, which drives the exciter 110 via the gear train 106, thus rotating the eccentric mass 138 about the exciter shaft 114, imparting vibration of the plate 126.

By utilizing a gear train 74, 106 to transfer torque from the electric motor 58, 94 to the exciter 50, 110, the plate compactors 42, 90 of FIGS. 2-4 achieve a longer runtime than an embodiment in which the electric motor is isolated from the exciter and provides torque to the exciter via a belt.

Although the invention has been described in detail with reference to certain preferred embodiments, variations and modifications exist within the scope and spirit of one or more independent aspects of the invention as described.

Various features of the invention are set forth in the following claims.

What is claimed is:

1. A compactor comprising:
a plate;
an electric motor coupled to the plate and including a first shaft configured to rotate about a first rotational axis;
an eccentric mass coupled to a second shaft and configured to rotate about a second rotational axis in response to receiving torque from the electric motor, wherein the first rotational axis is parallel to the second rotational axis;
a battery configured to provide power to the electric motor; and
a gear configured to receive torque from the electric motor, the gear configured to transmit the torque to the second shaft to rotate the eccentric mass.

2. The compactor of claim 1, wherein the gear is a first gear, and further comprising a second gear coupled to the second shaft, the first gear configured to transmit torque from the electric motor to the second gear.

3. The compactor of claim 2, wherein the battery is supported on a platform, and wherein the compactor further comprises a vibration isolator coupling the platform to the plate.

4. The compactor of claim 3, wherein the platform is configured as a housing, and wherein control electronics are located within the housing.

5. The compactor of claim 4, further comprising a frame configured to couple the housing and the plate.

6. The compactor of claim 3, further comprising control electronics, and wherein the vibration isolator couples the control electronics to the plate.

7. The compactor of claim 6, further comprising a handle, and wherein the vibration isolator couples the handle to the plate.

8. The compactor of claim 1, wherein the first shaft rotates at a first rotational speed, wherein the gear drives the second shaft at a second rotational speed, and wherein the first rotational speed is equal to the second rotational speed.

9. The compactor of claim 1, wherein the first shaft rotates at a first rotational speed, wherein the gear drives the second shaft at a second rotational speed, and wherein the first rotational speed is faster than the second rotational speed.

10. The compactor of claim 1, wherein the first shaft rotates at a first rotational speed, wherein the gear drives the second shaft at a second rotational speed, and wherein the first rotational speed is slower than the second rotational speed.

11. The compactor of claim 1, wherein the gear is located on an end of the electric motor, and wherein the eccentric mass is located on a side of the electric motor adjacent the end.

12. A compactor comprising:
a plate;
a handle;
a vibration isolator coupling the handle to the plate;
an electric motor coupled to the plate and including a first shaft configured to rotate about a motor axis;
an exciter coupled to the plate and configured to vibrate the plate in response to receiving torque from the electric motor, wherein the exciter includes a second shaft parallel with the motor axis and an eccentric mass attached thereto;
a battery configured to provide power to the electric motor; and
a gear train rotationally coupling the first shaft and the second shaft, wherein the gear train transfers torque from the electric motor to the exciter, causing the eccentric mass to rotate.

13. The compactor of claim 12, further comprising control electronics configured to control operation of the electric motor.

14. The compactor of claim 13, wherein the vibration isolator couples the control electronics to the plate.

15. The compactor of claim 14, wherein the vibration isolator couples the battery to the plate.

16. A compactor comprising:
a plate;
an electric motor coupled to the plate and including a first shaft configured to rotate about a motor axis;
control electronics configured to control operation of the electric motor;
a vibration isolator coupling the control electronics to the plate;
an exciter coupled to the plate and configured to vibrate the plate in response to receiving torque from the electric motor, wherein the exciter includes a second shaft parallel with the motor axis and an eccentric mass attached thereto;
a battery configured to provide power to the electric motor; and
a gear train rotationally coupling the first shaft and the second shaft, wherein the gear train transfers torque from the electric motor to the exciter, causing the eccentric mass to rotate.

17. The compactor of claim 16, wherein the vibration isolator couples the battery to the plate.

18. The compactor of claim 17, wherein the battery is supported on a platform, wherein the vibration isolator couples the platform to the plate, and wherein the compactor further comprises a handle extending from the platform, the handle configured for manipulation by a user to move the compactor.

19. The compactor of claim 18, wherein the electric motor and the exciter are coupled to the plate without a vibration isolator therebetween.

20. The compactor of claim 16, wherein the gear train is located on an end of the electric motor, and wherein the exciter is located on a side of the electric motor adjacent the end.
